(19) United States
(12) Patent Application Publication
(10) Pub. No.: US 2005/0178213 A1
(43) Pub. Date: Aug. 18, 2005

(54) Device for determining finger rotation using a displacement sensor

(75) Inventor: Jason J Skowronski, Raleigh, NC (US)

Correspondence Address: Jason Skowronski, 9608 Berryville Ct, Raleigh, NC, 27167, US

(73) Assignee: Jason J Skowronski, Raleigh, NC (US)

(21) Appl. No.: 10/906,251

(22) Filed: Feb. 10, 2005

Related U.S. Application Data
(60) Provisional application No. 60/544,480, filed on Feb. 13, 2004.

(51) Int. Cl. G01L 1/00

(52) U.S. Cl. 73/862

(57) ABSTRACT

Instead of measuring finger bend directly, such as with a strain gauge, a device for determining finger rotation using a displacement sensor is provided. It allows for a mechanical translation of a joint rotation into a displacement on the finger bone where it is more convenient and inexpensive to install a sensor. It achieves this displacement as a result of the changed path length when the joint is bent. Several applications are suggested including the application to a universal joint which includes a pivot point to allow for measuring two axes of rotation at once.

### CROSS-REFERENCE TO RELATED APPLICATIONS

This application is entitled to the benefit of Provisional Patent Application Ser. No. 60/544,480 filed on Feb. 13, 2004.

### BACKGROUND

1. Field of Invention

The invention suggests a new device for determining finger rotation using a displacement sensor, which is an important function of sign-language recognition gloves.

2. Prior Art

Numerous methods for measuring finger position exist. U.S. Pat. No. 5,047,952 describes the measurement of finger bend using strain gauges. A commercially available use of this technology is Immersion Technology's CyberGlove which uses it to measure every joint in the hand. VPL Research's DataGlove uses the amount of light returned from a fiber-optic cable to determine the amount of bend. Exos' Dextrous Hand Master makes use of mechanical exoskeletal sensors. U.S. Pat. No. 6,428,490 describes using a linkage structure of bend sensors throughout the body. These methods suffer from the problem of being too expensive or too bulky for the common consumer. This invention allows for using mass produced and more energy efficient displacement sensors and cheap plastics. U.S. Pat. No 6,651,352 shows using a displacement sensor to measure wrist angle but it does not discuss finger angle. It also uses a cable instead of a lever which requires the use of a spring.

### SUMMARY

Rather than measure the finger bend directly this invention shows how to translate the finger bend into a displacement. This provides a way to use commonly available, inexpensive displacement sensors to determine finger rotation. Devices are shown for hinge and universal joints. These approximate well the types of joints in the human hand.

### DRAWINGS—FIGURES

FIG. 1 shows a glove with two hinge-type angle measuring devices over the interphalangeal joints of the index finger, one universal-type angle measuring device with pivot bracket and two-axis displacement sensor over the metacarpophalangael joint, duplicate hinge-type devices over the wrist, and a hinge-type device used in conjunction with an angular displacement sensor on the carpometacarpal joint.

### DRAWINGS—REFERENCE NUMERALS

(1) bendable lever
(2) linear displacement sensor with plunger-type actuator
(3) microcontroller
(4) glove
(5) pivot bracket
(6) hinge joint on two-axis displacement sensor
(7) angle measuring device applied outside joint path of travel
(8) angular displacement sensor
(9) duplicate angle measuring devices at an angular offset

### DETAILED DESCRIPTION

Finger position is generally described as the angular position of the joints in the hand. However, it is difficult to mount an angular position sensor to the joints of the hand. Instead, mechanical methods are presented to convert the angular displacement of the joints to translations along the bones of the finger. The displacement sensor's output can be returned to a computer where a calculation will be done to determine the state of the hand.

Translating a Rotation to a Displacement

Joint rotation can be translated to a displacement and be measured with a displacement sensor. This displacement can then be converted back into an angular displacement with a mathematical function.

This method requires a rotating joint with one or more arms and it measures the angular displacement between two of them. The rotating joint must have a non-zero radius. The preferred application is for a human finger.

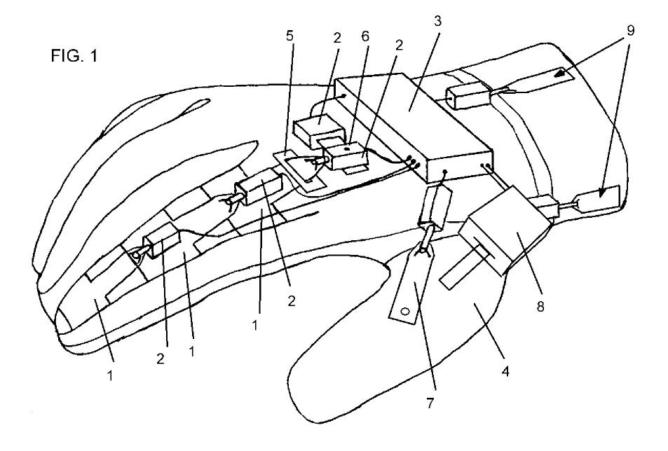

Referring to FIG. 1, a displacement sensor 2 is attached to one of the arms. It should remain at a fixed distance from the joint. The degrees of freedom in the displacement sensor should be appropriately chosen for the number of degrees of freedom wished to be measured in the joint. I will discuss applications to two common joints below.

A lever 1 connects the second arm to the displacement sensor. The mounting point on the second arm should remain fixed with respect to the joint. The lever is of a fixed length. When the joint rotates the lever will push and/or pull on the actuator of the displacement sensor.

The reason a displacement results is because the path length between the two mounting points on the two arms changes when the joint rotates, however the length of the lever does not change. This creates a displacement in position between the end of the lever and the displacement sensor. The lever can be flexible or rigid and contain joints for bending.

The method of converting the displacement back into an angular position is specific to the type of joint and lever used. However, in all cases a mathematical function is found. This function may be solved for angular displacement as a function of measured displacement. This function may be programmed into a computing device 3 so that when the inputs are given from the sensor the proper angles are calculated. This computing device can be on the glove itself, or the outputs of the sensors can be transferred to another computer for calculating.

It is not necessary to determine the angles of the joints in order to obtain a useful result from the device. The device output may be fed into a neural network and the neural network can be trained to produce a desired function of the sensor output. For example, the neural network can be taught to output an ‘a’ with a downward movement of the pinky. Thus, letters can be identified without determining angles. Therefore, the only requirement for the output of the sensors is that the displacement is some function of the rotation between the arms. However, using the device to determine angles will be the preferred embodiment since it is more computationally efficient to determine the angles and perform kinematics calculations to determine finger position than it is to maintain a neural network. The use of kinematics to determine finger positions and the training of neural networks to produce a desired function are considered common knowledge to one well acquainted with the field and prior art.

Application to a Hinge Joint

A hinge joint has only one degree of freedom; it bends along a single axis. To calculate this angle we only need to measure one displacement. If the lever is placed in the joint's path of travel, as is the case in interphalangeal and metacarpophalangael joints the lever must be a bendable lever and bend over the joint.

First, let us consider the case where the lever is in the joint's path of travel. In a human finger, the joint is approximated as a circle and the tops of the finger bones are tangent lines coming off the side of the circle. The variable part of the path length is then equal to the length of the arc between the intersection points of the arms.

Assuming the bendable lever 1 is completely flexible and takes on the circular shape of the rotating joint the change in perimeter length, and consequently, displacement in the displacement sensor 2, can be calculated with the simple equation: Displacement=2 Pi r (angle /360) where r is the radius of the joint and angle is the angle between the arms, in degrees. The equation can also be reversed to solve for angle from the displacement.

For a typical finger, the radius may be about 0.25 inches and total possible angular displacement 2 degrees. This results in a total displacement of about 0.48 inches. Adding about 0.05 inches for the thickness of a typical glove in the radius of the rotating joint results in a displacement of about 0.58 inches.

Additionally, it is possible to increase the displacement and thus the preciseness of the measurement by extending the bend point of the bendable lever beyond the intersection point. This requires the non-bending part of the bendable lever be made of a rigid material.

When the lever is outside the joint's path of travel 7 the displacement is equal to the length of the chord connecting the mounting joint of the lever and the mounting point of the displacement sensor. The angle can then be found using the cosine law. The two mounting points do not have to be equidistant from the joint but if that is the case then an additional trigonometric step must be taken.

Applications include the distal and proximal finger joints, the carpometacarpal joints, elbows, and knees, in addition to mechanical joints. It will be noted that these may not anatomically be hinge joints but they can be measured approximately using this method.

Application to a Universal Joint

A universal joint has two degrees of freedom; it bends along two axis but does not allow circumduction. Therefore, we need to measure two displacements in order to determine the two angles. One of the displacements will make use of the hinge method described above. The other angle can be measured either directly with an angular displacement sensor 8 or indirectly by mechanically converting the displacement to a translation.

The simplest option is to position a second hinge sensor at a 90 degree offset from the first sensor 9. This treats the universal joint as two hinge joints and allows two independent measurements to be taken. It should be noted that they do not have to take perpendicular measurements, but if they do not, additional calculation is required to calculate the angles.

If a second hinge sensor cannot be mounted it is possible to use a two-axis displacement sensor to measure the two angles. This method requires that we translate the two rotations to displacements along the two axes of the displacement sensor. The first axis will make use of the hinge method described above. To mechanically convert the second axis of rotation to a translation we constrain one axis of motion of the bendable lever with a pivot bracket 5. The pivot bracket will translate motion to the other side, where it will be measured by the displacement sensor. However, it will still allow the bendable lever to slide through on the first axis. The displacement on the sensor side is simply the ratio of the radii between the mounting point and the pivot bracket. This is the length of the bendable lever on the sensor side of the pivot bracket to the length of the bendable lever on the other side of the pivot bracket. The displacement will be along an arc.

If the displacement sensor senses movement along an arc this pivot method is a linear translation. However, it can be converted to a linear displacement by using a hinge 6 to connect the end of the bendable lever to the displacement sensor. If this is done it must be accounted for in the mathematical function to reintroduce linearity.

Applications include the metacarpal joints, shoulders, and hips, in addition to mechanical joints. It will be noted that these may not anatomically be universal joints but they can be measured approximately using this method.

Preferred Embodiment

The preferred embodiment of these devices is for sensing the angular positions of the joints in the human hand. This is allows us to create a sign-language recognition glove. Each of the finger joints has its own independent angle measuring device and all the devices are mounted to the glove 4. The interphalangeal joints are approximated using the hinge application described above. The metacarpals are approximated using the universal joint application with a pivot bracket 5 because it is inconvenient to mount a hinge sensor between the fingers. The carpometacarpal joint in the thumb can be measured with a hinge angle measuring device applied for the case where the lever is not in the joint's path of travel 7 and the sensor is mounted to the top of the hand along with an angular displacement sensor 8 at the base of the thumb for the second angle. Duplicate hinge angle measuring devices 9 are used for the wrist.

The preferred displacement sensor for the hinge method is a linear displacement sensor with a plunger-type actuator 2. For the universal joint sensor with a pivot bracket the preferred sensor is two linear displacement sensors with plunger-type actuators placed perpendicular to each other. As was discussed, a hinge 6 converts the arc-shaped movement into a linear translation. These sensors provide actuation means appropriate for the type of the translation produced.

The preferred design of bendable lever 1 is simply a flat strap of plastic. The strap is strong enough to push and pull on the sensor actuator. Also, it is long and bends over the joint. However, because it has some width it will not bend side to side. This allows it to be used in the universal joint with pivot bracket method. The pivot bracket 5 is also ideally constructed of plastic. It should be noted that if the bendable levers are long enough all the displacement sensors can be mounted on the back of the hand rather than the fingers, however this might lead to electromagnetic interference between the sensors depending on the type of sensor used.

The preferred type of computing device 3 to perform the angle calculation would be a microcontroller and will accept the inputs from the displacement sensors directly. The data it collects from the sensors will be sent to another computer for additional processing. This allows the glove to have a minimum of onboard processing which will save money and power.

1. A device for determining the rotation between two arms connected by a rotating joint comprising: a displacement sensor secured to the first arm, a fixed-length lever, one end of said lever being secured to the second arm, the other end of said lever being secured to the actuator of said displacement sensor whereby a rotation of said rotating joint will cause said lever to push and/or pull on said actuator and thus produce a measurable displacement.

2. The device of claim 1 wherein said rotating joint is, or can be approximated as, a hinge joint.

3. The device of claim 2 wherein said rotating joint is an interphalangeal or carpometacarpal joint.

4. The device of claim 2 wherein said rotating joint is an elbow or knee joint.

5. The device of claim 1 being applied in duplicate to a joint that is, or can be approximated by, a universal joint wherein the second device is at an angular offset from the first whereby the measurements can be used in combination to determine the amount of rotation between said arms.

6. The device of claim 5 wherein said rotating joint is a shoulder, hip, ankle, or radiocarpal joint.

7. The device of claim 1 wherein said rotating joint is, or can be approximated as, a universal joint, said displacement sensor is a two-axis displacement sensor, said lever bends only along one axis and includes a pivot bracket where said lever crosses said rotating joint whereby an x-axis rotation produces a displacement on at least one axis and a y-axis rotation produces a displacement on at least one axis of said two-axis displacement sensor.

8. The device of claim 7 wherein said rotating joint is a metacarpophalangael joint.

9. The device of claim 1 wherein said lever consists of a strap of flexible plastic.

10. Applying the device of claim 1 wherein said rotating joint is, or can be approximated as, a universal joint, along with an angular displacement sensor to determine the second spherical angle.

11. Mounting at least one of said device of claim 1 to a glove whereby finger bend can be measured.

12. The device of claim 1 wherein the output values of said displacement sensor are used to calculate the angle of rotation between said two arms.

13. The device of claim 1 wherein the output values of said displacement sensor are input into a neural network and the output of said neural network is the desired result.
